(19) United States
(12) Patent Application Publication
(10) Pub. No.: US 2014/0176714 A1
(43) Pub. Date: Jun. 26, 2014

(54) COLLISION PREVENTION WARNING METHOD AND DEVICE CAPABLE OF TRACKING MOVING OBJECT

(71) Applicant: AUTOMOTIVE RESEARCH & TEST CENTER, Lugang (TW)

(72) Inventors: Ming-Hung LI, Lugang (TW); Shun-Hung CHEN, Lugang (TW); Yu-Sung CHEN, Lugang (TW)

(73) Assignee: AUTOMOTIVE RESEARCH & TEST CENTER, Lugang (TW)

(21) Appl. No.: 13/727,213

(22) Filed: Dec. 26, 2012

(51) Int. Cl. G08G 1/16

(52) U.S. Cl. CPC G08G 1/166
USPC 348/148

(57) ABSTRACT

A collision prevention warning method and device capable of tracking a moving object, the method comprises the following steps. Firstly, capturing a plurality of continuous images in a front region of 180 degrees, through identifying category of at least an obstacle in these continuous images, to find a moving obstacle. Next, detect continuous relative positions of the moving obstacle and vehicle, to estimate a first collision region of the vehicle. Then, based on the continuous relative positions and an Extended Kalman Filter Algorithm, to estimate a second collision region of the moving obstacle. Finally, based on the first collision region and the second collision region to calculate a collision point. When the first collision region and the second collision region at least partially overlap each other, estimate out a collision time, and then output an alarm signal to warn the driver and raise driving safety.

### BACKGROUND OF THE INVENTION

1. Field of the Invention

The present invention relates to a collision prevention warning method and device, and in particular to a collision prevention warning method and device capable of tracking a moving object.

2. The Prior Arts

Nowadays, vehicles used as transport means has played an important and indispensable role in our daily life. However, in the crowded urban area, traffic accidents happen quite often. The causes of traffic accidents are many, and that are mainly due to environmental factor or human factor. In order to reduce the traffic accidents effectively, various vehicle driving safety warning technology have been developed to prevent collision of the driving vehicles, to raise driving safety.

For the driving safety warning devices, the most frequently utilized device is the GPS positioning system to detect the relative distance between an obstacle and the driving vehicle. However, the GPS is restricted by the environmental factor, for example, a vehicle is driving in a region studded with shielding objects, then the GPS can not detect the obstacle, so for the drivers, its application is limited. Other devices such as distance measuring sensor, image sensor can also be utilized. The distance measuring sensor is used to detect obstacle in a single direction; while the image sensor is used in wide area vision detection, to assist the driver to have a complete grasp of the relative distance between the driving vehicle and the obstacle, to reduce traffic accidents.

Moreover, in order to raise the accuracy of the estimated relative distance between a driving vehicle and an obstacle, a Kalman Filter Algorithm is proposed to estimate the relative distance between a driving vehicle and an obstacle, and the collision time. Yet, this algorithm is only applicable to an obstacle moving linearly, it can not predict the collision coming from objects of various directions to the driving vehicle, so its applicability is rather limited.

Therefore, presently, the design and performance of the driving safety warning method and device is not quite satisfactory, and it has much room for improvements.

### SUMMARY OF THE INVENTION

In view of the problems and shortcomings of the prior art, the present invention provides a collision prevention warning method and device capable of tracking a moving object, to overcome the drawbacks and shortcomings of the prior art.

A major objective of the present invention is to provide a collision prevention warning method and device capable of tracking a moving object. It is capable of classifying obstacles into categories based on length and width of the obstacle, to track the moving conditions of the obstacle, and raise the accuracy of estimated collision time.

A secondary objective of the present invention is to provide a collision prevention warning method and device capable of tracking a moving object. Wherein, a Extended Kalman Filter Algorithm is used to track the movement of an obstacle, and filter out the noise generated during sensing. In this approach, it is applicable to an obstacle moving non-linearly, to reduce effectively the unstable jittering of the collision time estimated through using the Kalman Filter Algorithm of the prior art, hereby raising its reliability in application.

In order to achieve the above objective, the present invention provides a collision prevention warning method and device capable of tracking a moving object, that is installed on a vehicle, comprising the following steps. Firstly, capturing a plurality of continuous images, to identify at least an obstacle in these continuous images, and to obtain the image pixel characteristic parameters and the geometric characteristic parameters such as width and length of the obstacle. Then, utilize a binary tree sorter, to sort the obstacles into various categories speedily, to find at least a moving obstacle based on the categories of the obstacle. Since the moving obstacle can move linearly or non-linearly, therefore, the continuous relative positions of the moving obstacle and the vehicle are detected first, to estimate out the first collision region of the vehicle. Then, calculate the speed, direction, and position of the moving obstacle based on the continuous relative positions and through using an Extended Kalman Filter Algorithm, to obtain a second collision region of the moving obstacle. Finally, obtain a collision point based on the first collision region and the second collision region, to determine if the first collision region and the second collision region at least partially overlap each other. In case the answer is positive, calculate to obtain a collision time, and output an alarm signal to warn the driver in time; otherwise, repeat the step of capturing a plurality of continuous images.

In addition, the present invention provides a collision prevention warning device, installed on a vehicle, including: at least two image capturing units, a vehicle body signal sensor unit, an image processing module, a central processor(CPU), and an alarm unit. Wherein, the at least two image capturing units fetch a plurality of images in a front region of 180 degrees, to obtain near field images and far field image to enlarge the detection scope. The image processing module is connected electrically to the two image capturing units, to identify the relative positions of the vehicle and at least an obstacle in the images, and to obtain the geometric characteristic parameter such as length and width of the obstacle and the image pixel characteristic parameter. Then, use a binary tree sorter to sort the obstacles and among them at least a moving obstacle into various categories. The vehicle body signal sensor unit is used to sense the dynamic signal of the vehicle. The central processor is connected electrically to the vehicle body signal sensor unit and the image processing unit, and it utilizes the moving obstacle and the dynamic signal of the vehicle to calculate the relative positions of the moving obstacle and the vehicle, so as to estimate and obtain the first collision region of the vehicle. Then, it utilizes the Extended Kalman Filter Algorithm to obtain a second collision region of the moving obstacle, and then it estimates and obtains a collision point based on the first collision region and the second collision region. When the first collision region and the second region at least partially overlap, the central processor calculates a collision time, and outputs a control signal. The alarm unit is connected electrically to the central processor, to receive the control signal and output a corresponding alarm signal, to warn the driver in time of the impending collision.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from this detailed descriptions.

### BRIEF DESCRIPTION OF THE DRAWINGS

The related drawings in connection with the detailed descriptions of the present invention to be made later are described briefly as follows, in which:

FIG. 1 is a system block diagram of a collision prevention warning device capable of tracking a moving object according to the present invention;

FIG. 2 is a flowchart of the steps of a collision prevention warning method capable of tracking a moving object according to the present invention;

FIG. 3 is a schematic diagram of the ways to detect geometric characteristic parameters of an obstacle according to the present invention;

FIG. 4 is a schematic diagram of the ways to estimate the collision point and time according to the present invention; and

FIG. 5 is a flowchart of the steps of detecting a moving obstacle according to the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

The present invention provides a reliable collision prevention warning method and device capable of tracking moving objects, that is able to provide more accurate alarm signal to the driver, informing him of the collision point and collision time, so that the driver may have a complete grasp of the relative position and direction of the driving vehicle and the obstacle, to prevent collisions and avoid traffic accidents.

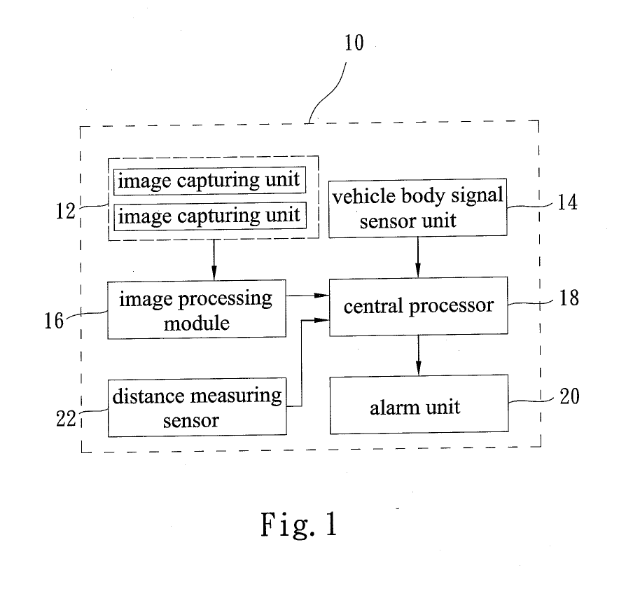

Refer to FIG. 1 for a system block diagram of a collision prevention warning device capable of tracking a moving object according to the present invention. The collision prevention warning device is installed on a vehicle, including at least two image capturing units 12, a vehicle body signal sensor unit 14, an image processing module 16, a central processor 18, and an alarm unit 20. Wherein, the at least two image capturing units 12 capturing a plurality of continuous images in a front region of 180 degrees, to obtain near field images and far field images to enlarge the detection scope. The vehicle body signal sensor unit 14 is used to sense the dynamic signals of the vehicle. The image processing module 16 is connected electrically to the two image capturing units 12, to identify the far field and near field images in the continuous images, and the inclination angle of the two image capturing units 12, so as to identify at least an obstacle. It also calculates the continuous relative positions of the obstacle and vehicle, to sort the obstacles into categories and sort out at least a moving obstacle speedily by using a binary tree sorter as based on the geometric characteristic parameter of length and width, and the image pixel characteristic parameter of the obstacle. The central processor 18 is connected electrically to the vehicle body signal sensor unit 14, the image processing module 16, and the alarm unit 20. The vehicle body signal sensor unit 14 is used to sense the dynamic signal of the vehicle, such as the driving direction, and driving speed. The central processor 18 calculates the continuous relative positions of the moving obstacle and the vehicle based on the dynamic signals of the driving vehicle and the moving obstacle, to estimate the first collision region of the vehicle. It then utilizes the Extended Kalman Filter Algorithm to obtain a second collision region of the moving obstacle, and then it estimates and obtains a collision point based on the first collision region and the second collision region. When the first collision region and the second region at least partially overlap, the central processor calculates a collision time and outputs a control signal. Upon receiving the control signal, the alarm unit 20 outputs an alarm signal, to warn the driver in time to prevent an impending collision.

In the descriptions mentioned above, in addition to the two image capturing units 12 used to capturing images of the obstacle, it can also used in cooperation with at least a distance measuring sensor 22, that is installed on the vehicle and connected electrically to the central processor 18, to detect on time the relative positions of the moving obstacle and the vehicle. The distance measuring sensor 22 can be a radar sensor, an optical radar sensor, a super sonic sensor, or an infrared sensor.

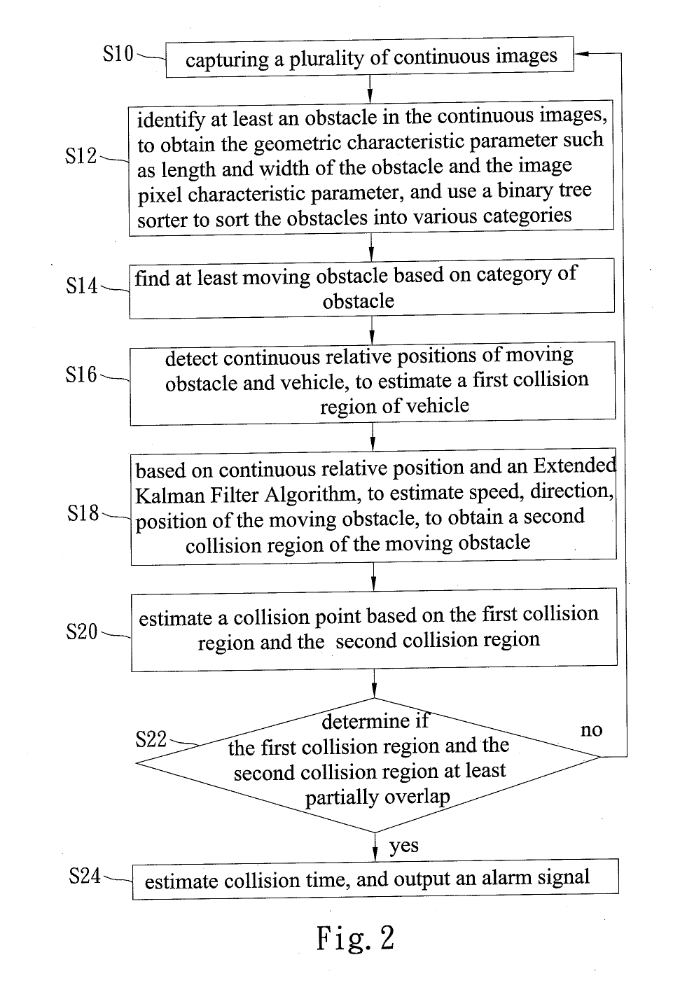

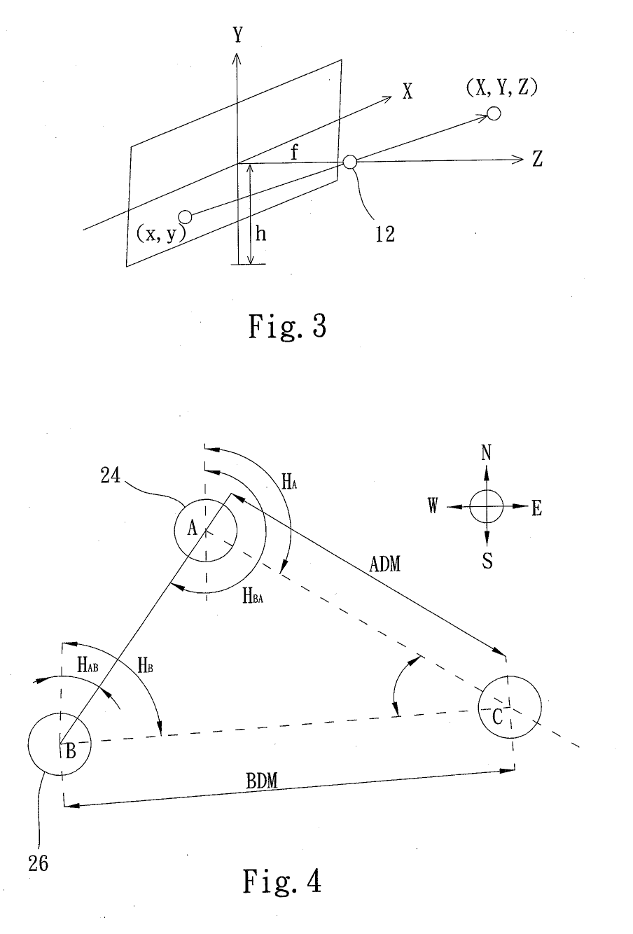

To further understand the collision prevention warning method of the present invention. Refer to FIGS. 1 and 2. FIG. 2 is a flowchart of the steps of a collision prevention warning method capable of tracking a moving object according to the present invention, comprising the following steps. Firstly, perform step S10, utilize at least two image capturing units 12 to fetch respectively a plurality of continuous images of far field image and near field image, to enlarge the detection scope. Next, as shown in step S12, utilize the image processing module 16 to identify at least an obstacle in the continuous images, and utilize a characteristic algorithm to obtain geometric characteristic parameter of length and width, and the image pixel characteristic parameter of the obstacle. In case the obstacle is located in front, then use a binary tree sorter to sort the obstacles speedily into various categories. Also, refer to FIG. 3 for a schematic diagram of the ways to detect geometric characteristic parameters of an obstacle according to the present invention. Wherein, it shows that the characteristic algorithm includes the following equations:

$$\frac{Y}{Z} = \frac{y}{f}$$

$$\frac{X}{Z} = \frac{x}{f}$$

$${Y}^{′} - h = \frac{Y - Z tan ( w )}{cos ( w ) + tan ( w ) \cdot sin ( w )}$$

Wherein, f is the focal length of the image capturing unit (such as the distance from the image plane to center of the lens); x, y are the pixel position of the image plane, namely the origin of the image plane. The origin is a center point of the image plane, such as 720*480 image, while (x,y) is the center point (360,240) of the image plane; X,Y,Z are the universal coordinates of the obstacle relative to the image capturing unit; and h is the installation height of the image capturing unit.

Through the processing of the image processing module 16, geometric characteristic parameter of length and width, and the image pixel characteristic parameter of the obstacle can be obtained, such that the obstacles can be sorted into various categories, such as pedestrian, motorcycle, large passenger truck, small passenger truck, or road environment. Wherein, Histogram of oriented gradient (HOG) or Haar Feature can be used to identify obstacle characteristic, and in cooperation with sorters, such as Support Vector Machine (SVM) sorter or Artificial Neural Network (ANN) sorter, to accurately sort the obstacles into categories such as pedestrian or motorcycle. Or the geometric characteristics of image width and height are used in cooperation with LDA characteristic space transformation to sort the obstacles into categories such as large passenger truck and small passenger truck. Subsequently, as shown in step S14, based on the category of the obstacle and the continuous moving images of the obstacle, the image processing module 16 finds and obtains at least a moving obstacle, namely the tracked moving object of the present invention.

Then, as shown in step S16, detect the continuous relative positions of the moving obstacle (such as a person) and the vehicle, to estimate and obtain the first collision region. Wherein, upon identifying the continuous images by the image processing module 16, it detects the continuous relative positions of the moving obstacle and the vehicle. Or, the integrated image capturing unit 12 and the distance measuring sensor 22 are used to detect the continuous relative positions of the moving obstacle and the vehicle. However, regardless of which way is used for detection, the first collision region of the vehicle can be estimated based on the continuous relative positions of the moving obstacle and the vehicle.

Since the moving obstacle 24 is not restricted to move linearly, in order to estimate more accurately the moving conditions of the obstacle, as shown in step S18, based on the continuous relative positions, the central processor 18 detects the relative distance and relative angle of the moving obstacle and vehicle, then estimate speed, direction, and position through using an Extended Kalman Filter Algorithm, and then obtain the second collision region of the moving obstacle. Wherein, the Extended Kalman Filter Algorithm includes the following equations:

$$A = [ \begin{matrix}1 & 0 & 0 & cos ( ϕ ) \times Δ t \\ 0 & 1 & 0 & sin ( ϕ ) \times Δ t \\ 0 & 0 & 1 & 0 \\ 0 & 0 & 0 & 1\end{matrix} ] ; {\hat{x}}_{i - 1} = [ \begin{matrix}{xp}_{i} \\ {yp}_{i} \\ {ϕ}_{i} \\ {v}_{i}\end{matrix} ] ; and {\hat{x}}_{k}^{-} = A {\hat{x}}_{i - 1}$$

Wherein, xpᵢ is the position of the moving obstacle in x axis, ypᵢ is the position of the moving obstacle in y axis, vᵢ is the speed of the moving obstacle, φᵢ is the direction of the moving obstacle, Δt is the input sampling time of the continuous relative positions of the moving obstacle and the vehicle, A is the status transformation model of the moving obstacle, \hat{x}ᵢ₋₁ is the estimated vector of the previous status, and \hat{x}ₖ⁻ is the present observation vector.

Subsequently, as shown in step S20, estimate a collision point based on the first collision region and the second collision region. As shown in FIG. 4, position (A) of the moving obstacle 24, position (B) of the vehicle 26, and collision point (C) form a triangle. Wherein, the known parameters are: the driving angle (H_{B}) of the vehicle 26, the driving angle (H_{A}) of the moving obstacle 24, angle (H_{AB}) of the moving obstacle 24 relative to the vehicle 26, the angle (H_{BA}) of the vehicle 26 relative to the moving obstacle 24, and the straight line distance (D) of vehicle 26 relative to the moving obstacle 24. Based on the known parameters mentioned above, the two inner angles ∠A , ∠B, and the collision angle ∠C can be obtained. Then, based on the sine equations

$$\frac{sin ( ∠ A )}{BDM} = \frac{sin ( ∠ B )}{ADM} = \frac{sin ( ∠ C )}{D}$$

and after calculations, the distance between the position (B) of the vehicle 26 and collision point (C), and the distance between the position (A) of the moving obstacle 24 and collision point (C) can be obtained. Subsequently, as shown in step S22, the central processor 18 determines if the first collision region and the second collision region at least partially overlap each other. In case the answer is negative, repeat the step S10. Otherwise, it is quite possible that collision is going to happen in a few seconds. So, it executes the next step S24, namely, to estimate a collision time and issue an alarm signal, so that the driver may have a complete grasp in time of the relative positions and directions of the driving vehicle 26 and the moving obstacle 24, to prevent the accident from happening. Wherein, for the approach of estimating the collision time, refer to FIG. 4 for a schematic diagram of the ways to estimate the collision point and time according to the present invention. Wherein, the estimated collision time can be classified into longitudinal collision time and lateral collision time. The longitudinal collision time (t_{ADM}) of the moving obstacle 24 relative to the collision point (C) can be obtained through the following equations:

$${t}_{ADM} = \frac{ADM}{{V}_{A}} \pm \frac{{e}_{A}}{{V}_{A}} ; and$$

$${e}_{A} = α \cdot {obj}_{w}$$

Wherein, V_{A} is the speed of the moving obstacle, ADM is the distance between the moving obstacle and the collision point, e_{A} is the estimated error of the width of the moving obstacle, α is the error coefficient of the two image capturing unit capturing these continuous images, obj_{w} is width of the moving obstacle identified by the image capturing unit.

The longitudinal collision time (t_{BDM}) of the vehicle 26 relative to the collision point (C) can be obtained through the following equation:

$${t}_{BDM} = \frac{BDM}{{V}_{B}} \pm \frac{{e}_{B}}{{V}_{B}}$$

Wherein, V_{B} is the speed of the vehicle, e_{B} is an error range of speed of said vehicle, BDM is the distance between the vehicle position and the collision point.

Wherein, the longitudinal collision time refers to the time t_{ADM} required by the moving obstacle to reach the collision point (C) based on the speed of the moving obstacle and its distance ADM to the collision point (C), and the time t_{BDM} required by the driving vehicle to reach the collision point (C) based on the speed of the vehicle and its distance BDM to the collision point (C). In case t_{ADM} and t_{BDM} coincide, then that is the longitudinal collision time of the vehicle and the moving obstacle.

The determination of the lateral collision time refers to the scenario that, a lateral collision accident could first occur before the driving vehicle 26 and the moving obstacle 24 reaches the collision point, due to the overly large size in length or width of the moving obstacle (such as the large-sized container truck or the concatenated truck), such that the lateral collision time (t_{LSM}) of the driving vehicle 26 and the moving obstacle 24 must be taken into consideration, and that can be obtained through the following equation:

$${t}_{LSM} = \frac{D \cdot β}{{V}_{A} \cdot cos ( ∠ A ) + {V}_{B} \cdot cos ( ∠ B )}$$

Wherein, D is the straight line distance between the vehicle and the moving obstacle; the two inner angles ∠A , ∠B and the collision angle ∠C can be obtained based on the first collision region, the second collision region, and the collision point, and β is the error coefficient for the detected continuous relative positions of the moving obstacle and the vehicle. When t_{LSM} is less than a preset value, that is the lateral collision time of the vehicle and the moving obstacle.

Therefore, upon obtaining the collision point and the collision time, the central processor 18 outputs a control signal to an alarm unit 20. Then, the alarm unit 20 will output an alarm signal to warn the driver of the impending collision. Wherein, the alarm unit 20 can be a displayer, capable of displaying the overlapped images of the first collision region and the second collision region, and collision time. Or alternatively, the displayer can incorporate an audio system, to inform the driver in both video and audio ways of the information related to the impending collision.

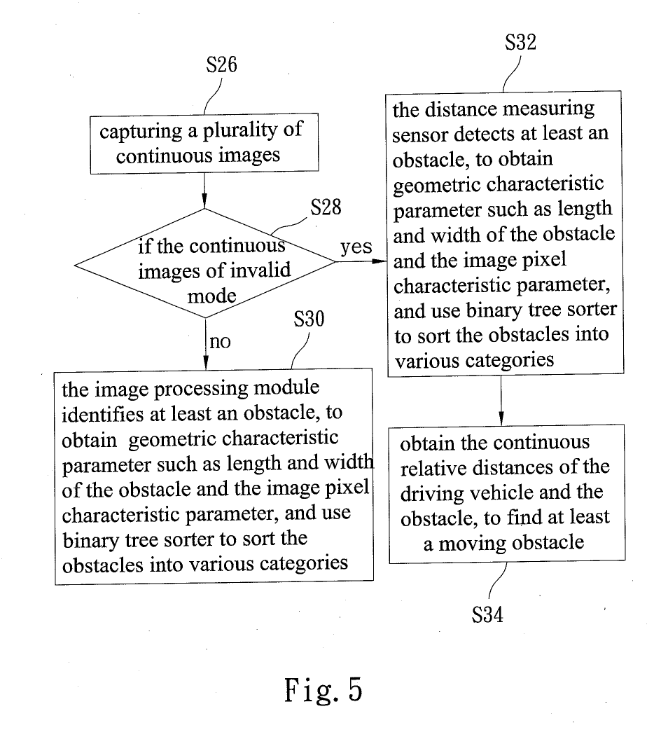

Finally, refer to FIGS. 1 and 5 at the same time. FIG. 5 is a flowchart of the steps of detecting a moving obstacle according to the present invention. When driving in an inferior illumination situation, such as due to dim light in the evening or in raining weather, special measures must be taken to ensure the results of detection is useful. As shown in FIG. 5, firstly, execute step S26, utilize at least two image capturing units 12 to capturing continuous images of the region of 180 degrees in front. Next, as shown in step S28, the image processing module 16 identifies the continuous images, and the central processor 18 determines if the image capturing unit 12 is in an invalid mode based on the clearness of the continuous images, namely determines if the continuous images contain at least a clear image of the obstacles. If the image capturing unit 12 is in a normal mode, then execute step S30, the image processing module 16 identifies at least an obstacle, and obtains the geometric characteristic parameter such as length and width of the obstacle and image pixel characteristic parameter. Otherwise, that indicates that the image capturing unit 12 is in an invalid mode, then execute step S32, the distance measuring sensor 22 such as light radar sensor (Lidar) detects at least an obstacle, and obtains the geometric characteristic parameter such as length and width of the obstacle and image pixel characteristic parameter, and then utilizes a binary tree sorter to sort the obstacles into various categories. Finally, as shown in step S34, the distance measuring sensor 22 obtains the continuous relative distance between the driving vehicle and the obstacle, to find at least a moving obstacle, that is the object of tracking of the present invention. Therefore, in the present invention, in addition to capturing images of an obstacle through the image capturing unit 12, in consideration of the problem of blurred images caused by environment factors, the central processor 18 controls the distance measuring sensor 22 to perform detection of obstacle position. As such, in the present invention, the image capturing unit 12 and the distance measuring sensor 22 are used alternatively in cooperation, to raise driving safety effectively.

Summing up the above, in the present invention, the characteristics such as length and width are used to sort the obstacles into various categories, to track the movement of the obstacles, to raise the accuracy of the estimated collision time, and to improve the shortcomings of the prior art that, it can only identifies the static or moving obstacles, but is not able to handle the error of estimated collision point and collision time caused by the sizes of the driving vehicle and the moving obstacle.

Further, though in the prior art, the Kalman Filter Algorithm is used to track the movement of the obstacle, but that is limited to estimate the linear movement of an object. However, in fact, the moving obstacles move mostly in a non-linear way. Therefore, in the present invention, an Extended Kalman Filter Algorithm is used to track movement of the obstacle, that includes linear and non-linear movements of the obstacles. In addition, it can filter out the noise generated during sensing, and reduce effectively the unstable uttering of the collision time estimated through using the Kalman Filter Algorithm of the prior art, hereby raising its reliability in application.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A collision prevention warning method capable of tracking a moving object, that is installed on a vehicle, comprising the following steps.
capturing a plurality of continuous images,
identify at least an obstacle in said continuous images, to obtain geometric characteristic parameters of width and length of said obstacle and image pixel characteristic parameters, and use a binary tree sorter to sort said obstacles into various categories,
find at least a moving obstacle based on category of said obstacle,
detect continuous relative positions of said moving obstacle and said vehicle, to estimate out a first collision region of said vehicle.
calculate speed, direction, and position of said moving obstacle based on said continuous relative positions through using an Extended Kalman Filter Algorithm, to obtain a second collision region of said moving obstacle; and
estimate a collision point based on said first collision region and said second collision region, to determine if said first collision region and said second collision region at least partially overlap each other, if answer is positive, calculate a collision time, and output an alarm signal; otherwise, repeat said step of capturing a plurality of continuous images..

2. The collision prevention warning method as claimed in claim 1, wherein in said step of identifying said obstacle in said image, a following characteristic algorithm is used to obtain the geometric characteristic parameters of width and length of said obstacle, and the image pixel characteristic parameter, said characteristic algorithm is as follows:
$${Y}^{′} - h = \frac{Y - Z tan ( w )}{cos ( w ) - tan ( w ) \cdot sin ( w )}$$
wherein, Y is a Y axis of an image capturing unit, w is a downward inclination of Y axis, h is installation height of said image capturing unit.

3. The collision prevention warning method as claimed in claim 1, wherein said obstacle is classified into pedestrian, motorcycle, large passenger truck, small passenger truck, or road environment.

4. The collision prevention warning method as claimed in claim 1, wherein in said step of detecting relative position of said moving obstacle and said vehicle, at least a sensor is used to detect relative distance of said moving obstacle and said vehicle, and said relative position of a relative angle.

5. The collision prevention warning method as claimed in claim 1, wherein said Extended Kalman Filter Algorithm includes following equations:
$$A = [ \begin{matrix}1 & 0 & 0 & cos ( ϕ ) \times Δ t \\ 0 & 1 & 0 & sin ( ϕ ) \times Δ t \\ 0 & 0 & 1 & 0 \\ 0 & 0 & 0 & 1\end{matrix} ] ; {\hat{x}}_{i - 1} = [ \begin{matrix}{xp}_{i} \\ {yp}_{i} \\ {ϕ}_{i} \\ {v}_{i}\end{matrix} ] ; and {\hat{x}}_{k}^{-} = A {\hat{x}}_{i - 1}$$
wherein, xpᵢ is a position of said moving obstacle in x axis, ypᵢ is a position of said moving obstacle in y axis, vᵢ is relative speed of said moving obstacle and said vehicle, φᵢ is a relative direction of said moving obstacle and said vehicle, Δt is input sampling time of said continuous relative positions of said moving obstacle and said vehicle, A is a status transformation model of said moving obstacle, \hat{x}ᵢ₋₁ is an estimated vector of a previous status, and \hat{x}ₖ⁻is a present observation vector.

6. The collision prevention warning method as claimed in claim 1, wherein
in said step of estimating said collision time, said collision time is classified into longitudinal collision time and lateral collision time, wherein:
said longitudinal collision time (t_{ADM}) of said moving obstacle relative to said collision point is obtained through following equations:
$${t}_{ADM} = \frac{ADM}{{V}_{A}} \pm \frac{{e}_{A}}{{V}_{A}} ; and$$
$${e}_{A} = α \cdot {obj}_{w}$$
wherein, V_{A} is speed of said moving obstacle, ADM is a distance between said moving obstacle and said collision point, e_{A} is an estimated error of width of said moving obstacle, α is an error coefficient of said at least two image capturing units capturing said continuous images, obj_{w} is width of said moving obstacle identified by said image capturing unit,
said longitudinal collision time (t_{BDM}) of said vehicle relative to said collision point is obtained through following equation:
$${t}_{BDM} = \frac{BDM}{{V}_{B}} \pm \frac{{e}_{B}}{{V}_{B}}$$
wherein, V_{B} is speed of said vehicle, BDM is distance between said vehicle and said collision point, e_{B} is an error range of speed of said vehicle, when t_{ADM} and t_{BDM} coincide, then that is said longitudinal collision time of said vehicle and said moving obstacle, said lateral collision time (t_{LSM}) of said vehicle and said moving obstacle is obtained through following equation:
$${t}_{LSM} = \frac{D \cdot β}{{V}_{A} \cdot cos ( ∠ A ) + {V}_{B} \cdot cos ( ∠ B )}$$
wherein, D is a straight line distance between said vehicle and said moving obstacle;
said two inner angles ∠A, ∠B and a collision angle ∠C are obtained based on said first collision region, said second collision region, and said collision point, and β is an error coefficient for detected continuous relative positions of said moving obstacle and said vehicle, when t_{LSM} is less than a preset value, then that is said lateral collision time of said vehicle and said moving obstacle.

7. A collision prevention warning device, installed on a vehicle, including:
at least two image capturing units, used to fetch a plurality of continuous images in a front region of 180 degrees;
a vehicle body signal sensor unit, used to sense a dynamic signal of said vehicle,
an image processing module, connected electrically to said two image capturing units, to identify continuous relative positions of said vehicle and at least a said obstacle in said images, to obtain a geometric characteristic parameter of length and width of said obstacle, and said image pixel characteristic parameter, then, use a binary tree sorter to sort said obstacles and among them at least a moving obstacle into various categories.
a central processor, connected electrically to said vehicle body signal sensor unit and said image processing module, and it utilizes said moving obstacle and said dynamic signal to calculate continuous relative positions of said moving obstacle and said vehicle, to estimate a first collision region of said vehicle, then, it utilizes said Extended Kalman Filter Algorithm to obtain a second collision region of said moving obstacle, and then it estimates and obtains a collision point based on said first collision region and said second collision region, when said first collision region and said second region at least partially overlap each other, said central processor calculates a collision time, and outputs a control signal; and
an alarm unit, connected electrically to said central processor, to receive said control signal and output an alarm signal.

8. The collision prevention warning device as claimed in claim 7, wherein said alarm unit is a displayer, capable of displaying overlapped images of said first collision region and said second collision region, collision point, and collision time.

9. The collision prevention warning device as claimed in claim 7, wherein said collision time is classified into longitudinal collision time and lateral collision time, said longitudinal collision time t_{ADM} of said moving obstacle relative to said collision point is obtained through following equations:
$${t}_{ADM} = \frac{ADM}{{V}_{A}} \pm \frac{{e}_{A}}{{V}_{A}} ; and$$
$${e}_{A} = α \cdot {obj}_{w}$$
wherein, V_{A} is speed of said moving obstacle, ADM is a distance between said moving obstacle and said collision point, e_{A} is an estimated error of width of said moving obstacle, a is an error coefficient of said at least two image capturing units capturing said continuous images, obj_{w} is width of said moving obstacle identified by said image capturing unit,
said longitudinal collision time (t_{BDM}) of said vehicle relative to said collision point is obtained through following equation:
$${t}_{BDM} = \frac{BDM}{{V}_{B}} \pm \frac{{e}_{B}}{{V}_{B}}$$
wherein, V_{B} is speed of said vehicle, BDM is distance between said vehicle and said collision point, e_{B} is an error range of speed of said vehicle, when t_{ADM} and t_{BDM} coincide, then that is said longitudinal collision time of said vehicle and said moving obstacle,
said lateral collision time (t_{LSM}) of said vehicle and said moving obstacle is obtained through following equation:
$${t}_{LSM} = \frac{D \cdot β}{{V}_{A} \cdot cos ( ∠ A ) + {V}_{B} \cdot cos ( ∠ B )}$$
wherein, D is a straight line distance between said vehicle and said moving obstacle; said two inner angles ∠A , ∠B and said collision angle ∠C are obtained based on said first collision region, said second collision region, and said collision point, and β is an error coefficient for detected continuous relative positions of said moving obstacle and said vehicle, when t_{LSM} is less than a preset value, then that is said lateral collision time of said vehicle and said moving obstacle.

10. The collision prevention warning device as claimed in claim 7, wherein said two image capturing units fetch respectively a near field image and a far field image, to calculate said relative positions of said vehicle and said obstacle based on inclination angles of said obstacle and said two image capturing units in said near field image and said far field image.

11. The collision prevention warning device as claimed in claim 7, wherein
said image processing module utilizes a following characteristic algorithm to obtain said geometric characteristic parameters of width and length of said obstacle and said image pixel characteristic parameters, said characteristic algorithm is as follows:
$${Y}^{′} - h = \frac{Y - Z tan ( w )}{cos ( w ) + tan ( w ) \cdot sin ( w )}$$
wherein, Y is a Y axis of said image capturing unit, w is a downward inclination of Y axis, h is an installation height of said image capturing unit.

12. The collision prevention warning device as claimed in claim 7, further comprising:
at least a distance measuring sensor, connected electrically to said central processor, said distance measuring sensor detects said relative positions of said moving obstacle and said vehicle, in cooperation with said two image capturing units.

13. The collision prevention warning device as claimed in claim 12, wherein
said distance measuring sensor is a radar sensor, an optical radar sensor, a super sonic sensor, or an infrared sensor.

14. The collision prevention warning device as claimed in claim 7, wherein
said obstacle is classified into pedestrian, motorcycle, large passenger truck, small passenger truck, or road environment.
